(19) United States
(12) Patent Application Publication
(10) Pub. No.: US 2013/0036651 A1
(43) Pub. Date: Feb. 14, 2013

(54) HUNTING DECOY

(71) Applicants: William Johns, Tuscaloosa, AL (US); John Chadwick Sparks, Cottondale, AL (US); Hunter Sparks, Cottondale, AL (US)

(72) Inventors: William Johns, Tuscaloosa, AL (US); John Chadwick Sparks, Cottondale, AL (US); Hunter Sparks, Cottondale, AL (US)

(21) Appl. No.: 13/208,086

(22) Filed: Aug. 11, 2011

(51) Int. Cl. A01M 31/06; A01M 31/00

(52) U.S. Cl. 43/3; 43/2

(57) ABSTRACT

A hunting decoy may comprise a glove; and a simulation of a head of a quarry attached to the glove. In operation a hunter may carry the decoy to a desired hunting location and position the simulation into a position that is visible to the quarry. The hunter may move the simulation to imitate natural head movements of the quarry.

### BACKGROUND OF THE INVENTION

The present invention generally relates to hunting decoys and methods for employing decoys. More particularly, the invention relates to decoys which are hand-held by a hunter during use.

When hunting land-based birds such as turkeys, it is advantageous for a hunter to use a decoy. In order to reach a desired hunting location the hunter may walk long distances while carrying hunting equipment. A decoy that may simulate a full-sized turkey may be quite large and difficult to carry into a hunting location.

As can be seen, there is a need for a compact and light-weight decoy for hunting large land-based birds such as turkeys.

### SUMMARY OF THE INVENTION

In one aspect of the present invention, a hunting decoy may comprise: a glove; and a simulation of a head of a quarry attached to the glove.

In another aspect of the present invention, a hunting decoy may comprise: a handle; and a simulation of a head of a quarry attached to the handle.

In still another aspect of the invention, a method of hunting a quarry may comprise the steps of: providing for carrying a simulation of a head of the quarry to a desired hunting location; providing for positioning the simulation into a position that is visible to the quarry; and providing for moving the simulation to imitate natural head movements of the quarry.

These and other features, aspects and advantages of the present invention will become better understood with reference to the following drawings, description and claims.

### BRIEF DESCRIPTION OF THE DRAWINGS

FIG. 1 is a perspective view of a hunting decoy in accordance with an exemplary embodiment of the invention;

FIG. 2 is a perspective view of a hunting decoy in accordance with a second exemplary embodiment of the invention; and

FIG. 3 is a perspective view of a hunting decoy in accordance with a third exemplary embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide for compact decoys which may simulate a portion of a body of a hunter's quarry. More particularly, the invention may provide such a decoy that may be made movable by a hunter in order to simulate natural movement patterns of the quarry.

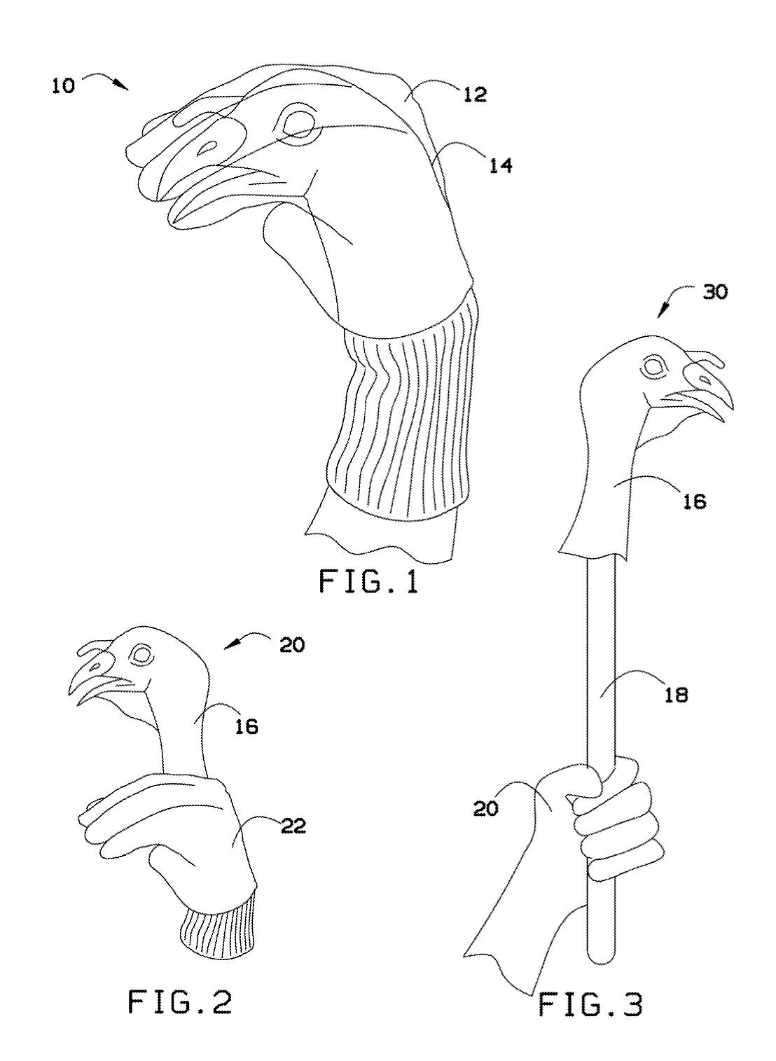

Referring now to the FIG. 1, it may be seen that an exemplary embodiment of a decoy 10 may comprise a glove 12 with a decoy image 14. While the decoy 10 may be effective for hunting various types of prey, it may be particularly effective for hunting turkeys. In the context of its use for turkey hunting, the glove 12 may be produced from multi-colored fabric (sometimes referred to as “camouflage”) that may simulate natural vegetation in the hunting environment. The image 14 may comprise a simulation of a turkey head and it may be painted or printed onto the camouflage of the glove 12.

In operation, a camouflage-clothed hunter (not shown) may position himself in a desired hunting location and then raise his hand and the glove 12 to a level above the ground that may correspond to a normal height of a turkey's head. The hunter may move his gloved hand to simulate natural motions of a turkey. For example, the hunter may rotate his hand to simulate a turkey looking around or the hunter may lower his hand from time to time to simulate a turkey seeking food. A turkey may observe this activity then, being naturally gregarious and/or competitive, the turkey may move toward the hunter.

Referring now to FIG. 2, an exemplary embodiment of a decoy 20 may comprise a glove 22 and a simulation of a bird head 16 which may be a three dimensional figure of the head. The glove 22 may be constructed from camouflage fabric. The bird head 16 may be attached to the glove 22. The head 16 may be a molded resin simulation of a bird head which may be painted or otherwise colored to replicate actual coloration patterns of the quarry.

In an exemplary embodiment, the head 16 may comprise a freeze-dried head of a previously killed bird. Such a freeze-dried head may be painted with taxidermy materials and may be made to very accurately replicate features of an actual live bird. Use of a freeze-dried head may be particularly effective when the decoy 20 is to be used for turkey hunting.

Referring now to FIG. 3, an exemplary embodiment of a decoy 30 may comprise the bird head 16 mounted on a handle 18 which may be held in a hand 20 of the hunter.

As described with respect to the decoy 10 of FIG. 1, the decoys 20 and 30 may be moved by the hunter to simulate natural motions of a bird such as a turkey. For example, the hunter may rotate the head 16 to simulate a turkey looking around or the hunter may lower the head 16 from time to time to simulate a turkey seeking food.

It may be seen that the decoys 10, 20 and 30 may be light-weight and compact. Consequently, a hunter may readily carry one of these decoys into the field even if the hunter needs to travel a long distance on foot.

It should be understood, of course, that the foregoing relates to exemplary embodiments of the invention and that modifications may be made without departing from the spirit and scope of the invention as set forth in the following claims.

What is claimed is:

1. A hunting decoy comprising:
a glove; and
a simulation of a head of a quarry attached to the glove.

2. The decoy of claim 1 wherein the simulation is an image of the head painted or printed on the glove.

3. The decoy of claim 2 wherein the image is an image of a head of a turkey.

4. The decoy of claim 1 wherein the simulation is a three dimensional figure of the head attached to the glove.

5. The decoy of claim 4 wherein the three dimensional simulation is a simulation of a head of a turkey.

6. The decoy of claim 4 wherein the three-dimensional simulation is a freeze-dried head of a previously killed quarry.

7. A hunting decoy comprising:
a handle; and
a simulation of a head of a quarry attached to the handle.

8. A method of hunting a quarry comprising the steps of:
providing for carrying a simulation of a head of the quarry to a desired hunting location;
providing for positioning the simulation into a position that is visible to the quarry; and
providing for moving the simulation to imitate natural head movements of the quarry.

9. The method of claim 8 wherein the quarry is a turkey.

10. The method of claim 8 wherein the step of moving the simulation comprises hand movement of a hunter.
